(19) United States
(12) Patent Application Publication
(10) Pub. No.: US 2011/0160881 A1
(43) Pub. Date: Jun. 30, 2011

(54) RFID occupancy sensor

(76) Inventor: Thomas L. Grey, San Marcos, CA (US)

(21) Appl. No.: 12/928,880

(22) Filed: Dec. 21, 2010

Related U.S. Application Data
(60) Provisional application No. 61/284,727, filed on Dec. 24, 2009.

(51) Int. Cl. G06K 7/01; G06F 17/00

(52) U.S. Cl. 700/90

(57) ABSTRACT

A lighting control system is disclosed. The lighting control system includes detector units that communicates with portable RFID modules. Based on the identification and/or detected locations of RFID modules, the detector units control lights within a building. The lighting in further embodiments is a building security system, wherein lighting data, RFID history data and/or occupancy data is transmitted to the central security computer. The central security computer is configured to store lighting data, RFID history data and/or occupancy data, sound alarms and/or enable the operation of one or more remote building systems, such as locks, building doors, building cabinets and commuters.

### RELATED APPLICATION(S)

This patent application claims priority under 35 U.S.C. 119 (e) of the U.S. Provisional Patent Application Ser. No. 61/284,727 filed Dec. 24, 2009, and titled “RFID OCCUPANCY SENOR.” The U.S. Provisional Patent Application Ser. No. 61/284,727 filed Dec. 24, 2009, and titled “RFID OCCUPANCY SENOR” is hereby incorporated by reference.

### FIELD OF THE INVENTION

The invention relates to light management systems, devices and methods. More particularly, the present invention relates to light management systems that use radio frequency identification for controlling lights.

### BACKGROUND

Radio frequency identification (RFID) is a technology that is well known in the art. It is commonly used in office environments to identify and track employees, including allowing access to the building and other controlled spaces. Typically, a small RFID transmitter circuit (tag) is embedded in an identification card. Typically, the tag has no internal power supply, otherwise known as a passive tag. An RFID reader transmits a radio signal either continuously or in a pulsed or discontinuous manner. When a tag is in the vicinity of a reader, the radio frequency energy provides power to the tag so that it powers up and transmits a unique number programmed into the tag. The reader then transmits the tag number to a central computer running a program that matches the number with a database of employees who have been assigned the unique numbers. The reader's location in a building is also known so the program can identify that a particular employee has passed the location of the reader, so the employees location is known. Active tags are also sometimes used wherein the tag has a power supply, such as a small battery, so that it can regularly transmit its unique number, which is received by readers located throughout a facility. Readers are often located in individual offices or cubicles so that a computerized security system can know when an employee is in their work space.

Occupancy sensing for control purposes, such as controlling lighting in a space, is also well known in the art. Typically, an occupancy sensor uses a technology, such as ultrasound, infrared sensing, microwave radar, or acoustic monitoring, to attempt to sense when a space is occupied by a person. If occupancy is detected, then a signal is sent to a controller to activate a function, such as turning on the local lights or turning on a local heating/air conditioning system.

Typically, the sensor is also used to detect when vacancy occurs so that these same functions can be turned off, thereby saving energy. Occupancy sensors require special installation and location in a space to optimize their sensing capability and also add cost to a system.

What is needed is a occupancy sensor that does not add cost and complexity to a control system.

### SUMMARY

The invention is configuration of an RFID reader to act as an occupancy sensor for a space. The reader may be part of a larger security or attendance system for a building or configured solely for functioning as an occupancy sensor. In use, the RFID reader reads any RFID tag in its space. The tags may be active or passive. When a tag is read, the reader sends a signal to a controller to turn on a controlled function, such as lighting. The signal may be sent via any convenient method, such as low voltage wiring or wirelessly. Unlike typical use of an RFID tag as a security system component, the use of an RFID system as an occupancy sensor does not require an identification step. The occupancy sensor does not care who entered the space, only that at least one person entered a space.

In a first embodiment, the reader is configured only as an occupancy sensor. Typically, the reader would be placed along the inside of the door frame to an office or the opening to a cubicle. Preferably, the reader employs a radio frequency signal direction limiter, for example, that may limit the signal to a cone or triangle. This allows the reader to be oriented such that the signal monitors the space into which the employee must pass to enter their work space while ignoring the space outside so as to limit false triggers by employees passing the space opening in a hallway, for example. The reader may also be positioned at a desk area with reader signal direction and strength set up so that the employee's tag is recognized as they approach the desk area, as opposed to the opening of the work space. Multiple readers may be so positioned and oriented if the space is larger, such as an executive office suite. The reader may be incorporated into a wall box switch. The reader may also be incorporated into standard occupancy sensors, thereby providing the benefit of multiple occupancy sensing methods to reduce false triggers that may turn on lights when there is no occupant. The controller may be configured to recognize the tag for the person assigned to the work space, and control the area in a particular manner to match that person's preference, such as dimming certain lights or adjusting the target temperature to a particular level. In that case, the controller may also be configured to control the space in a default manner if anyone else's tag is read, such as turning on only a single light, perhaps at a dimmed level, or leaving the temperature setting at the unoccupied setting, to save energy.

In a second embodiment, the reader is part of a security or attendance system. The reader may be configured to send a signal to the security system and separately to the control system. Alternatively, the reader may send a signal just to either the security or control system, when then routes the signal to the other system. For example, a short range reader may be used for building access, unlocking a door when a known tag is read. The building access system may then send a signal to a controller to turn lights on, preferably at a dim level initially to save energy, at the area near the door and at default areas around the building. If it is after hours, the controller may be set to control lights specific to the person assigned to the tag. For example, lights may be controlled from the entry to the persons office only.

In a third embodiment, the controller that controls a common space, such as an entrance or hallway, may be set up to respond to any tag and control the space according to selectable default parameters, such as light level or temperature. In an after hours situation where a security guard is patrolling the building, the control system may activate lights as the guard gets near an area and then deactivate the lights after the guard leaves the area.

In a fourth embodiment, the controller may be temporarily programmed to control a space in a particular manner in response to one or more particular tags. For example, a conference room may be scheduled by an employee for a presentation at a particular time. In addition to scheduling the space, the employee may also schedule a particular operating mode for the controlled function, such as lighting. When the employee enters the room, the lighting can be controlled in a presentation mode or “scene”, as is known in the art, for the time allotted for the presentation. If the employee continues to occupy the space after the scheduled time, such as if the presentation runs later than anticipated, then the system may continue the special mode or may reset the lights back to a default occupied mode.

### BRIEF DESCRIPTION OF THE DRAWINGS

FIG. 1 shows system for controlling lighting using an active RFID module, in accordance with the embodiments of the invention.

FIG. 1B shows system for controlling lighting using an passive RFID module, in accordance with the embodiments of the invention.

FIG. 2 shows a system for controlling lighting in a work-space, in accordance with the embodiments of the invention.

FIG. 3 illustrates an RFID that is configured to respond to selected detector units within a lighting system, in accordance with the method of the present invention.

FIG. 4 is a block diagram outlining the steps for controlling lights and building systems, in accordance with the method of the present invention.

### DETAILED DESCRIPTION OF THE INVENTION

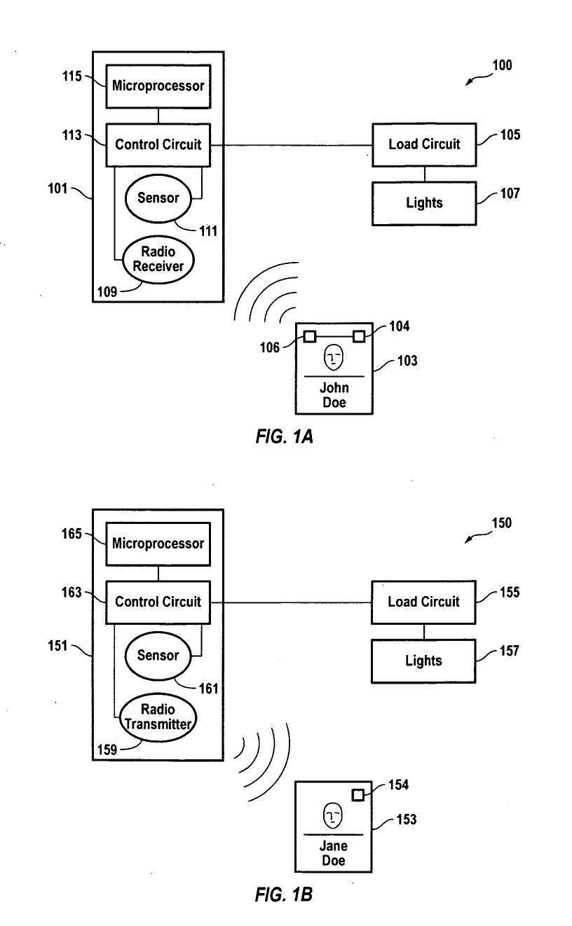

FIG. 1 shows system 100 for controlling lighting 107 using an active RFID module 103, in accordance with the embodiments of the invention. The active portable RFID module 103 includes a radio transmitter 104 and power supply 106 that transmits RFID data to a detector unit 101. When the detector unit 101 senses that the active RFID module 103 is within a detection field of the defector unit 101, the detector unit 101 closes a load circuit 105 and turns on the lights 107. After a period of time, when the detector unit 101 no longer sense that the active RFID module 103 is within the detection field, the defector unit 101 opens the load circuit 105 to turn off the lights 107.

The detector unit 101 includes a radio receiver 109 for receiving the RFID data from the active portable RFID module 103 and a control circuit 113 that includes, for example, a relay for operating the load circuit 105. In further embodiments of the invention, the detector unit 101 includes a micro-processor 115 with memory for running various lighting programs and storing lighting and/or RFID history data. RFID data includes, for example, personal user information, authorization codes and/or location information, such as time and duration of time that a location is occupied by a person wearing the active portable RFID module 103.

In further embodiments of the invention, the detector unit 101 includes a sensor 111 for detecting occupancy within a detection area of the detector unit 101, even in the absence of the active RFID module 103. The sensor 111 is an ultra-sonic sensor, an infrared sensor, a micro-wave sensor and an acoustic sensor or combination thereof. In operation, when the sensor 111 detects an occupant within a detection field of the detector unit 101, detector unit 101 closes a load circuit 105 to turns on the lights 107 and when the sensor 111 no longer detects an occupant within the detection field, the defector unit 101 opens the load circuit 105 to shut off the lights 107. The detector unit 111, in yet further embodiments of the invention, includes means for transmitting RFID data and/or occupancy data to a central security system. If, for example, lights are turned on by detection of an occupant by the sensor 111 within the detection field of the detector unit 101, and the occupant is not wearing a RFID module or badge, an alarm is triggered and/or a record of an unauthorized occupant is stored in a memory device.

FIG. 1B shows system for controlling lighting 150 using an passive RFID module 153, in accordance with the embodiments of the invention. The passive portable RFID module 153 includes a transmitter coil 154 that is sensed by a control unit 151 via a radio transducer 159. As described above, when the detector unit 151 senses that the passive RFID module 153 is within a detection field of the defector unit 151, the detector unit 151 closes a load circuit 155 to turns on the lights 157 and when the detector unit 151 no longer senses that the passive RFID module 153 is within the detection field, the defector unit 151 opens the load circuit 155 to shut off the lights 157, after a time delay.

The detector unit 151 also includes a control circuit 163 with a relay for operating the load circuit 155, a micro-processor 155 with a memory for running various lighting programs and storing lighting and/or RFID history data. The detector unit 151 also includes a fail-safe sensor 161 for controlling the lights 157 independent of the passive RFID module 153, as described with reference to FIG. 1A.

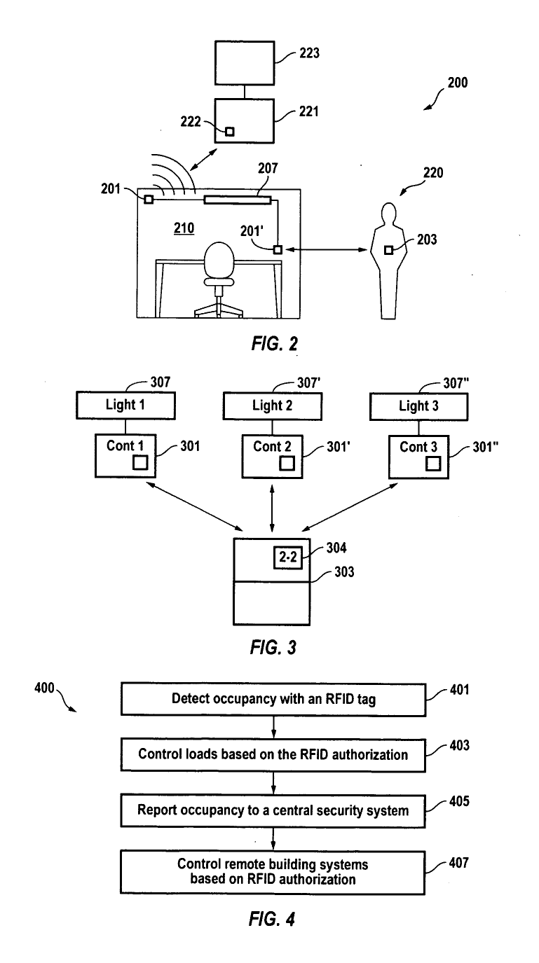

FIG. 2 shows a system 200 for controlling lighting in a work-space 210, in accordance with the embodiments of the invention. The system 200 includes portable RFID modules 203 that are worn by people 220 within the work-space 210. The system 200 also includes detector units 210 and 201′ that are configured to control lights 207 within the work-space, as described above with reference to FIGS. 1A-B. One or more of the detector units 210 and 201′ include a means for transmitting lighting data, RFID history data and/or occupancy data to a central security computer 221, where the lighting data, RFID history data and/or occupancy data is stored in a memory device 222. The means for transmitting lighting data, RFID history data and/or occupancy data to a central computer 221 is a wireless radio transmitter, a cable or any other suitable means for transmitting data. In further embodiments of the invention, when the detector units 210 and 201′, detect an authorized occupant, the central security computer 221 enables operation of one or more remote building systems 223, such as locks, building doors, building cabinets and commuters.

FIG. 3 illustrates an RFID module 303 that is configured to control selected detector units 301, 301′ and 301″ within a lighting system, in accordance with the method of the present invention. In operation the RFID module 303 equipped with a security RFID transmission device 304. The detector units 301, 301′ and 301″ communicate with the RFID module 303 either actively or passively, such as described above with reference to FIGS. 1A-B and 2. In operation, only the detector units 301, 301′ and 301″ that are programmed or coded to respond to the security RFID transmission device 304 will control the corresponding lights 307, 307′ and 307. In further embodiments the detector units 301, 301′ and 301″ enable operation of selected remote building systems, such as described above.

FIG. 4 is a block diagram 400 outlining the steps for controlling lights and building systems. In accordance with the method of the invention, in the step 401 locations of a RFID badges are determined using detector units. After the locations of a RFID badges are determined in the step 401, in the step 402 lights are controlled within a building based on detected locations of the RFID badges, authorization codes and/or a combination thereof. Together or independently with the step 402 of controlling the lights, in the step 405 lighting data, RFID history data and/or occupancy data is transmitted to a central security computer. After the lighting data, RFID history data and/or occupancy data is transmitted to the central security computer, the central security computer enables operation of one or more remote building systems, such as described above.

The present invention has been described in terms of specific embodiments incorporating details to facilitate the understanding of the principles of construction and operation of the invention. As such, references, herein, to specific embodiments and details thereof are not intended to limit the scope of the claims appended hereto. It will be apparent to those skilled in the art that modifications can be made in the embodiment chosen for illustration without departing from the spirit and scope of the invention.

What is claimed is:

1. A system comprising:
a) a portable RFID module; and
b) a detector unit configured to control lights based on a condition of the portable RFID module that is sensed by the detector unit.

2. The system of claim 1, wherein portable RFID module is an RFID badge and the condition sensed by the detector unit is the location of the RFID badge or an authorization code of the RFID badge.

3. The system of claim 1, wherein the portable RFID module is a passive portable RFID module with a transmitter coil and the detector unit includes radio transducer for reading the passive portable RFID module.

4. The system of claim 1, wherein the portable RFID module is an active portable RFID module that includes a radio transmitter and power supply and wherein the detector unit includes a radio receiver for reading the passive portable RFID module.

5. The system of claim 1, wherein the detector unit further comprises a motion sensor for controlling the lights based on detection of an occupant within a detection field of the detector unit.

6. The system of claim 1, further comprising means for transmitting RFID data to a central computer system.

7. A system comprising:
a) portable RFID modules; and
b) detector units that are configured to control lights in selected locations of a building based on locations of the portable RFID modules within the building.

8. The system of claim 7, wherein the detector units are programed to respond a selected portion of the portable RFID modules.

9. The system of claim 7, wherein the portable RFID modules are passive portable RFID modules.

10. The system of claim 7, wherein the portable RFID modules are active portable RFID modules.

11. The system of claim 7, wherein the detector units further include a sensor for controlling the lights based on detection of occupants within detection fields of the detector units.

12. The system of claim 11, wherein the motion sensor comprises one or more of an ultra-sonic sensor, an infrared sensor, a micro-wave sensor and an acoustic sensor.

13. The system of claim 7, wherein the detector units further comprises means for transmitting history data of locations of the portable RFID modules within the building to a remote computer.

14. A method comprising:
a) detecting locations of a plurality of RFID badges with detector units;
b) controlling lights within a building based on detected locations of the RFID badges; and
c) reporting the detected location of the RFID badges to a central security system.

15. The method of claim 14, further comprising controlling the lights based on detected occupancy of the locations using a motion sensor.

16. The method of claim 15, wherein the motion sensor comprises one or more of an ultra-sonic sensor, an infrared sensor, a micro-wave sensor and an acoustic sensor.

17. The method of claim 14, further comprising controlling a remote building system based on detected location of the RFID badges.

18. The method of claim 17, wherein the remote building system includes one or more of building locks, building doors, building cabinets, and building computers.

19. The method of claim 14, wherein the portable RFID modules are passive portable RFID modules with transmitter coils and the detector units include radio transducers for reading the passive portable RFID modules.

20. The method of claim 14, wherein the portable RFID modules are active portable RFID modules that include a radio transmitter and a power supply and the detector units include a radio receiver for reading the passive portable RFID modules.
